(19) United States
(12) Patent Application Publication
(10) Pub. No.: US 2016/0294483 A1
(43) Pub. Date: Oct. 6, 2016

(54) Low Energy Technology for Real Teleportation.

(71) Applicant: Gerald Paul Greelis, Palm Bay, FL (US)

(72) Inventor: Gerald Paul Greelis, Palm Bay, FL (US)

(21) Appl. No.: 14/673,896

(22) Filed: Mar. 31, 2015

(51) Int. Cl. H04B 10/90

(52) U.S. Cl. CPC H04B 10/90

(57) ABSTRACT

It is a common belief today real teleportation of large objects, definitely humans, is science fiction; beyond normal (paranormal). The problem with this assessment (even though promoted among noted scientists) teleportation is happening in front of our eyes today. The Chinese published proof by means of a scientific experimentation that teleportation is real as suggested in a USAF Teleportation Report in 2004. Knowledge to teleport was provided by Nikola Tesla 107 years ago and the science to teleport provided by Albert Einstein and Theodor Kaluza 86 years ago. With today's technology it is time to bring real teleportation into reality. It is time to teleport it is time to add another non-physical aspect into our technology, a non-physical intelligence capable of communicating through Einstein's 4^{th} dimension and providing a foundation for a new world of real teleportation. Teleportation that is attainable in using a precisely tuned octahedron crystal in resonance along with, associated amplification devices and information technology to provide the capability to transfer physical objects, with all their non-physical attributes to predetermined destinations instantaneously. Michio Kuku, a popular theoretical physicist, commented teleportation will probably happen in some future decade or maybe in a century using entanglement; it being a physics ‘engineered solution’. This patent disagrees, real teleportation is not a physics solution, and instead it is an information technology solution. Information Technology today is already using a paranormal (software) means to achieve its objectives, adding another paranormal apparatus provides real teleportation to its list of achievements, therefore making teleporting a reality today, not decades or centuries later. As Tesla stated over a hundred years ago, our world is much more than just physical.

Three different technologies required to perform real teleportation of large objects, including humans. First, a teleporter; second, a landing zone; third, a communication system between the two previous technologies; today the internet can serve that purpose. The internet needs only communicate preliminary transfer information; not to perform the actual teleportation. All three based upon Information Technology (IT); this being the first generation of real teleportation. The application example used in this patent, is for illustration purposes only. The patent itself is for the technology and how it is used; there are numerous real teleportation applications, including human transportation developed from this technology.

Real teleportation never moves objects through any medium, all objects are transferred from point A to point B, instantaneously, no exceptions. A good analogy is when changing information on our technology screens today, we have two options ‘select and drag (or wipe)’ and ‘cut and paste’. The difference between the two methods is ‘how’ the actual object(s) is changed from its selected location to its final destination. In the select/drag, the user exerts energy and momentum, one must physically drag a stylus or finger, plus time is involved in performing this operation. In the cut/paste application, user energy, momentum, or time is not involved with the actual changing (better term: transfer/teleport) the information to its final destination. The user exerts no energy or force in the transfer of the object.

In both the analogy's events, an intelligent technology was used to change the object or information's location, after the user selected and determined the final destination. However, only in one event, cut/paste required no physical effort on the user's part in the actual information displacement to its new selected destination. In this case, the information was just transferred (teleported) to the selected destination by the intelligent technology (or processor).

Take this scenario one step further, one view a picture on the internet, a web server thousands of miles from the user, they select it and cut it; then pastes it in their Picture Folder. All pictures being an object comprised of information; it was never scanned, no information was ever altered the only thing changed was its location. The picture is no longer on the server, thousands of miles away; it now resides in the user's Picture Folder, effectively being teleported by an intelligent processor(s). Copy/paste would only cloned it, not teleported it.

If one can understand this analogy, they have a good understanding of how real teleportation works, and how alleged UFOs could reach our planet from anywhere in the Universe instantaneously. Most of us have been teleporting objects (information) for many years, it is now time to start teleporting objects. It is possible the Universe (nature) has been teleporting objects for millions, if not billions of years; now it is humanity's time.

### GROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING

NOT APPLICABLE

### BACKGROUND OF THE INVENTION

The invention's origin could be traced back to 1992 when a research project started, not for teleportation, but for authoring a fiction book titled ‘Beginning of u & i’. The book based upon two fictional, non-physical entities seeking what and why they were created at the beginning of our Universe. It is this twenty-three years and counting, of research that prompted this invention. The content required researching science, religion and metaphysical information to provide answers to u and i basic questions. This research discovered:

At the beginning of the 20^{th} Century, Nikola Tesla returned to New York from Colorado with a host of new ideas for inventions, the primary one was ‘free electricity and without wires’. However, based upon speeches he was giving; being quoted in the New York Times articles in April 1908 (which available on the web), he was alluding to moving objects in the air with technology. These quotes were not proposing just small objects, but instead, even huge objects, i.e. planets. Tesla had to been experimenting with teleportation, even though the word ‘teleport’ was some 23 years into the future, he was providing the knowledge of real teleportation using technology; it being 107 years old. Needless to say, Tesla's technology probably was very high energy waves; however, the knowledge of the teleportation existed.

In 1929, twenty-one years after Tesla's speeches, two mathematicians from Germany, Albert Einstein and Theodor Kaluza, published papers on their Unified Field Theories. The theory's objective was to combine the electromagnetic (EM) and gravity (GR) forces together into one force. The unique thing that came from these two mathematical theories, besides obtaining the forces goal, was an added fourth dimension required outside our three dimensional space. Later, this fourth dimension was calculated to be about the size of a Planck length, which today would be viewed as containing both waves and their associated energy force. A Planck length is beyond any current measurement means today. Einstein's theory was engineered by Gabriel Kron on electrical devices for GE in 1934. What this alludes to, waves coming into our dimension on a path undetectable by us, but the question is from where? It appears the potential knowledge existed in 1908 and the science developed in 1930 to teleport.

### World War Two Experiments

During the war years both the U.S. and Germany were experimenting with Tesla's, Einstein's and Kaluza's theories in creating war weaponry using technology devices. These experiments being all top secret and even today many denied with their documentation hidden or destroyed. However, alleged teleportation events supposedly did occurr, and not just small objects. It is alleged very high energy EM waves were used during these experiments with some extreme unexpected effects happening outside the experiment's proposed objectives. Alleging both matter embedding and teleportation took place.

### Information Technology (IT) Explosion

The information technology opens the door to low energy, real teleportation; not any physics solution, i.e. entanglement, etc. It is perceived an ‘external smart source’ residing outside our Universe being more IT oriented than any argument of being physical matter. This ‘external smart source’, explained in more detail later, would be a computer like device and most likely categorized as paranormal by most physicists today. Our IT world uses mind over matter, or software exclusively to program the technology in achieving purposeful applications today. Interfacing with this ‘external smart source’ to achieve matter manipulation, requires both the needed knowledge and technology within this area of expertise, versus a PhD degree in Physics. Even with this expertise still more is needed to teleport. In order to interact with this ‘external smart source’ another additional technology is crucial—a paranormal antenna.

### BRIEF SUMMARY OF THE INVENTION

Teleportation is real as suggested by Eric Davis, PhD in his 2004 Teleportation Report to the U.S. Air Force. He suggests, it just requires a paranormal method to achieve it. He was referencing the 1980's and the late 1990's psychokinesis (PK) experiments conducted by the Chinese in performing real teleportation of many small objects. This patent agrees with Dr. Davis. Current technology required to perform real teleportation does need to be modified slightly toward (what some may be viewed as) a paranormal slant. The published experiments by the Chinese was conducted using current scientific methods to prove teleportation is a reality. However, little explanation existed in how this mind over matter (PK) application could actually perform teleporting. In knowing that our analogy necessitated intelligent engineers to develop the apparatus (CPU/processor), then an additional requirement of mind over matter or software, needed to create cut/paste; this same scenario is needed for (PK) teleportation. This will be explained in greater detail in the full description section below.

### Chinese Published Experiments Prove Teleportation is Real

Nikola Tesla provided the knowledge; Albert Einstein and Theodor Kaluza gave us the science. And two governments conducted top secret experiments that accidently produced teleporting early in the 20^{th} Century, all illustrating real teleportation of objects is feasible and could become a reality. So, what was missing, why are we not teleporting real objects, including humans, today? The technology to perform low energy teleportation, the capability to use IT versus high energy waves as was proposed in the last century, and still believed by many today.

### Tesla and Military Believed and Used Hi-Energy Waves to Teleport Objects

During the research for authoring a fiction book on the beginning of the Universe using science, religion and metaphysical sources, the inventor uncovered a unique device, from numerous sources, which could provide the capability to manipulate matter using low energy ‘smart’ waves. The device is capable to embed matter within other matter, levitate matter, and with the addition of current technology, perform safe and reliable teleportation of matter. In the investigation seeking to obtain this device, the experts in the field stated, we do not have the technology today to create this device. The device is an octahedron crystal tuned to a specific natural resonance frequency.

### A Tuned Octahedron Crystal Provides Low Energy Real Teleportation

The research uncovered a scientific theory that could have originated in the early 20^{th} Century, maybe even from Nikola Tesla. It states all matter is being constantly created from an ‘external smart source’ outside our three dimensions. All matter has an associated ‘information set’ being sent through a 4^{th} dimension that Einstein and Kaluza outlines in their unified field theories. This information set, in the form of waves coming into our dimension to create matter within a very tiny area known as a Planck Length; possibly has been creating matter since the Universe's beginning. Although this concept resides outside current scientific thinking, ‘thinking outside their box’; this concept and invention does not violates any current scientific, reverse-engineered, proven theories, hypothesizes, laws, etc.—just some thinking!

True teleportation of matter requires an ‘external smart source’ to achieve it!

### BRIEF DESCRIPTION OF THE SEVERAL VIEWS OF THE DRAWINGS

Three drawings included in the patent illustrating using a different scientific thinking and using current available technology to perform low energy teleportation. Keeping in mind a different scientific thinking which does not violate proven theories, hypothesizes or laws, so far reversed engineered. A theory possibly by geniuses and an inventor in the 20^{th} Century, not someone just creating gadgets, computer games, social networks, but a real true innovator!

FIG. 1

This figure is using one of many possible applications to illustrate a teleportation operation. The figure illustrates the basic components required to perform this application of teleportation. In conjunction with the components, the application consists of three very important phases or sets of procedures, each having a sequence of steps: 1) initiate the operation, 2) confirm the landing zone (destination) is ready, and 3) teleport the object. To complete these three phases, the six crucial components are required: 1) a Teleporter, 2) a Landing Zone, 3) the Internet, 4) a GPS System, 5) Computers, and 6) associated Electronics.

The teleporter is illustrated as a trellis-like structure to hold eight transmitters and their associated antennas which is required to dematerialize the object to be teleported. The teleporter is mounted on a 3-axis, precise gimbal structure to aim the object to its destination, i.e. the landing zone. A conveyor belt is required to initiate the object in transit down the heading to its destination. In the final step of the teleporter's operation, the transmitted waves surrounding the object negate the 4^{th} dimensional signal and dematerializes the object.

The landing zone, during the initiation phase, has a very important crucial role to play in ensuring a safe, reliable and successful teleporting event. The landing zone must be free of all objects. No exceptions. This is extremely important because teleporting can and will embed matter into other matter! The landing zone must have an active GPS system, because the teleporter needs to have the correct coordinates. They must be confirmed in real time before a successful secured teleport operation will happen. An encrypted code is sent to the landing zone to initiate an oscillator to transmit a series of coded waves into the zone, a sensor detects these waves. Then all confirmation data is sent back via the internet to the teleporter.

Upon receipt of the confirmed information from the landing zone, and verifying the GPS coordinates do agree, the teleporter's computer energizes the platform by pointing it to the landing zone, the conveyor belt is started with the object heading to its new destination. The object is dematerialized by an applied field of smart waves within the teleporter and then instantaneously rematerialized at the landing zone by the complementary waves.

FIG. 2

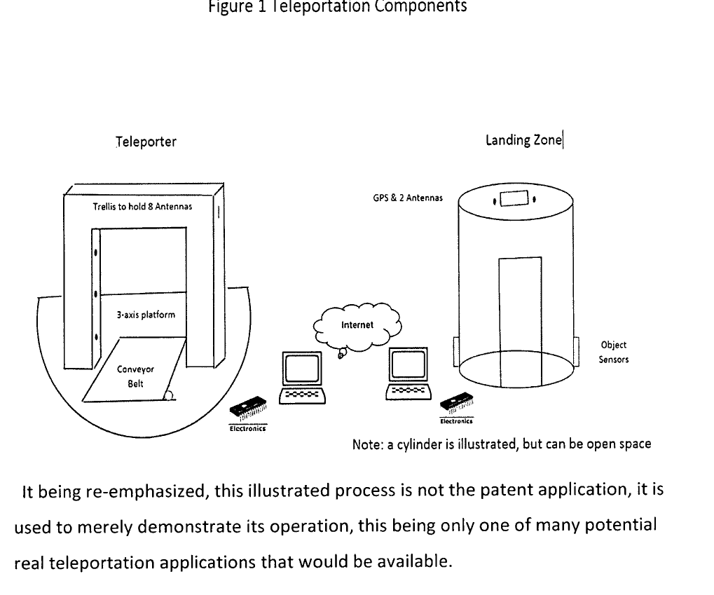

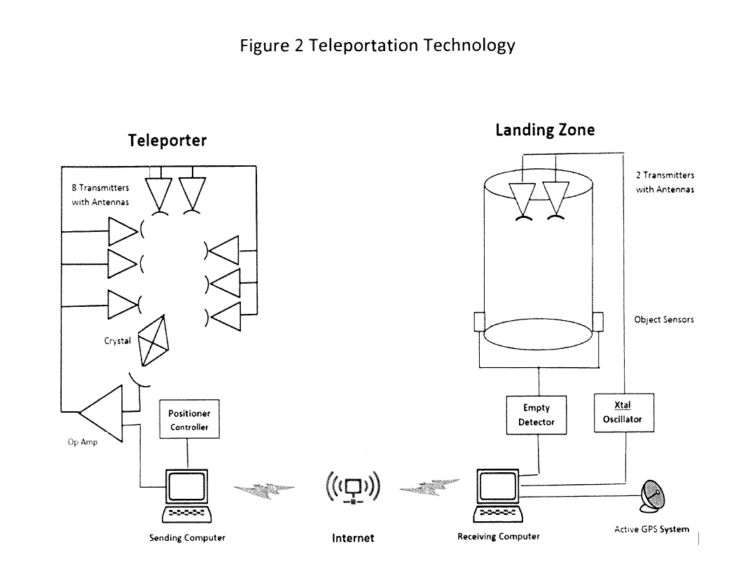

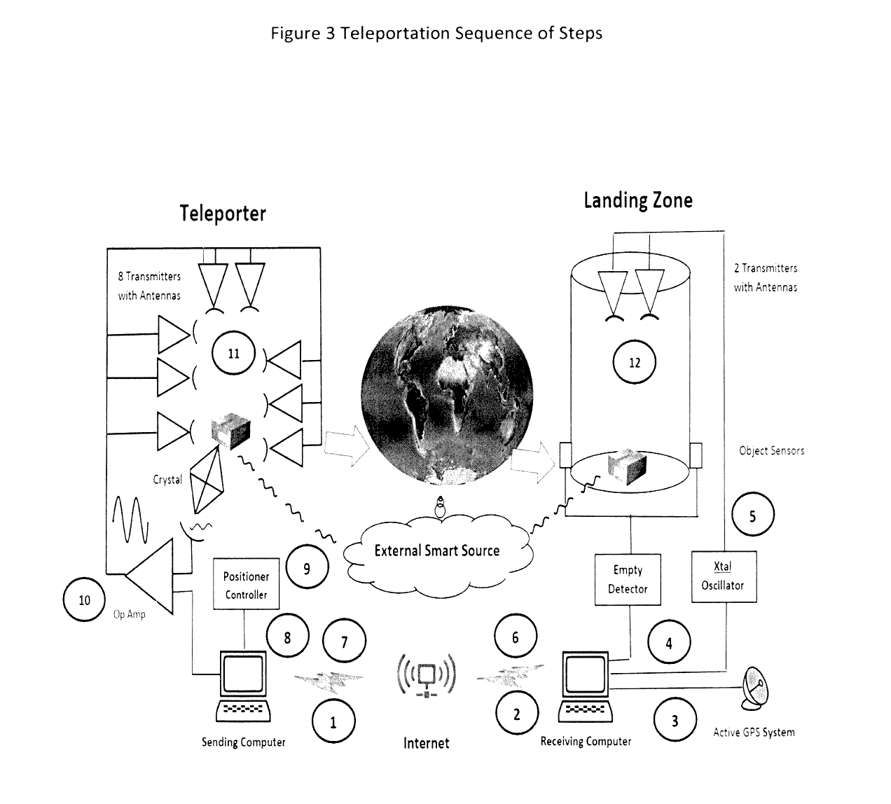

In FIG. 2, the drawing illustrates the technology needed to perform real teleportation for the same application described in FIG. 1. Again, wanting to re-empathize this is only an illustration of just one of many applications for teleportation. This particular application is not what the inventor is seeking to patent, it is the technology to teleport sought for the patent.

The teleporter consists of one key ingredient to this whole patent, that being the octahedron crystal. The crystal is positioned to detect the signal and information coming into our dimension through Einstein's and Kaluza's 4^{th} dimension. Keep in mind this being so tiny that science has ignored its existence since published in 1929 in the unified field theories.

The crystal intercepts the signal and performs some shaping characteristics and then passes the signal to an antenna being an input to a series of amplifiers. The signal being waves with both a carrier and information, modulated with certain vector angles, phasing and protocols. However, the result coming out of crystal into the amplifiers being only the carrier wave 180 degrees out of phase with the incoming signal. Applying this signal to transmitters and their associated antennas creating a field surrounding the subject object, which then negates the incoming signal and dematerializing the object; thus cutting the object as in our cut/paste analogy.

Now the technology needs to paste it at the landing zone. This is accomplished with a wave to contradict the ‘negating wave’ that was developed at the teleporter. Recall, everything is happening instantaneously so the negating signal at the landing zone in reality needs to be there before the object is dematerialized. This is accomplished with the Xtal oscillator, but it needs to be in phase with the incoming signal from the 4^{th} dimension. The Xtal oscillator is phase locked by a harmonic wave that was sent to the landing zone during its initiation phase through the internet from the teleporter. As the signal from the 4^{th} dimension passes through the proximity of the landing zone, the object is re-materialized or pasted. The object sensors detects the object and closes down the landing zone system.

FIG. 3

In FIG. 3, the twelve sequence of steps is illustrated through the complete teleporting process with numbering:
1. The process is initiated by the teleporter sending the teleport request and harmonic signal to the landing zone via the internet.
2. The landing zone performs the following processes
3. Sends back the GPS signal's coordinates
4. Verifies the landing zone is empty
5. Turns on Xtal oscillator and verifies the signal is present and in sync
6. Returns the ‘ready to go’ signal to the teleporter
7. Teleporter receives the ‘ready to go’ signal and starts the teleporting phase
8. Positions the platform to the exact heading to the landing zone
9. Energizes the conveyer belt moving the object into the field
10. The negating signal is pulsed to the transmitters
11. The object is dematerialized
12. The object travels through the earth to the landing zone and rematerializes

The teleportation system would be very secure, mainly because the beam will be traveling, almost in all cases, within the interior of the earth. This is accomplished by the precise coordinates being the floor of the landing zone. Therefore, a direct line of sight is used due to the curvature of the earth. This would send most teleporting beams transmitted below the surface and through the interior of the Earth. This could also be enhanced more with the teleporter being established below sea level.

### DETAIL DESCRIPTION OF THE INVENTION

### PK Teleportation

Many alleged teleportation events are happening, but only one ‘published’ scientific experiment conducted by the Chinese, as noted in a 2004 U.S. Air Force Teleportation Report by Eric Davis, PhD, suggests teleportation is real, by means of psychokinesis (PK). In order to make PK (Mind/Movement) a teleporting event, technically it needs to be renamed Telekinesis (TK) meaning (Distance/Movement). Although the inventor has not seen the videos or read the documentation from the Chinese experiments, which were translated by the DIA (Defense Intelligence Agency) it is believed Dr. Davis assessment to be true within respect that very low energy (brain waves) teleportation did occur. In reviewing all the alleged teleporting events, including the Chinese experiments and our analogy, one can ascertain three main ingredients appears to be a common denominator: intelligence, information and waves.

### Intelligence

The intelligence in our analogy was the processor executing software (mind over matter) created to perform the cut/paste event. So where is the intelligence for the Chinese TK experiments? Are they creating software (mind over matter) with their brain waves? Yes, they are performing those physical steps with their minds needed in selecting the object and its final destination. Every alleged teleportation event also requires some intelligence. In concluding therefore, to perform real teleportation, all transfer of objects will require some intelligence to execute the actual transfer, similar to the computer in the cut/paste analogy. This includes the Chinese TK experiments also, an intelligence beyond their brain waves. In effect, they are not moving matter with their mind, instead communicating to some external source; it is that ‘external smart source’ transferring their selected objects to their new destinations, similar to the processor performing it in the cut/paste analogy scenario.

Real teleportation requires some external intelligence!

### Information

The next ingredient is information. In the cut/paste analogy, information makes up the object and no manner what the object to cut/paste may be it can be reduced to stored information in the intelligent processor. In the Chinese experiments their objects, both inanimate and animate, required some information associated with them. Why? They transferred objects through container walls. No manner how powerful TK or PK can be, it cannot violate any natural physical laws discovered through our science. Therefore, those objects never moved through those walls. What was done, they were transferred beyond the walls and that could only be done if the objects had associated information—they in effect were cut/paste. If physical objects have an associated information, what would it be, where is this information stored?

### Waves

The last ingredient is waves, a disturbance within a medium. In the cut/paste analogy, the technology uses EM waves throughout the processor in transferring both instructions and information. In the Chinese (TK) experiments, waves become much more a prominent factor. Two aspects are required in making those objects follow a participant's brain waves. In the analogy, it is the mouse/finger selecting the object and determining its destination. In TK, the participant, in effect becomes that mouse/finger performing the same functions using their brain waves. Where are those waves being directed to and most important what is discerning the information coming from those participant's waves?

This implies for TK to ever work, all their objects requires an associated information set, and the external intelligence communicating with their subject objects through waves. The TK participant's brain waves were never communicating with the subject objects, but instead with some ‘external smart source’ creating those objects; the participant's brain waves are interpreted as commands (mind over matter, liken to software) by an external intelligent source. This ‘external smart source’ performs teleporting by just changing the destination information located within its dimension and then sends that object's information set to the new destination within our three dimension through Einstein's and Kaluza's 4^{th} dimension—in a similar manner as the processor performs in our cut/paste analogy.

### Paranormal and Technology

Current scientific thinking has a terminology for anything they cannot explain with their hypotheses and theories; being called paranormal—beyond normal. Thus both PK and TK being mind over matter would fall into this category. Many scientists have declared TK impossible because it violates the conservation laws of energy and momentum, plus it requires a force to move matter that has never been detected. The above description has answered these concerns using an ‘external smart source’ outside our three dimensional world. Obviously this source can also be viewed as an impossibility, and by some scientists as paranormal. With that said, the inventor wishes to quote one of the greatest geniuses and inventors of the 20^{th} Century on his view of paranormal, Nikola Tesla:

“the day science begins to study non-physical phenomena, it will make more progress in one decade than in all the previous centuries of its existence. To understand the true nature of the universe, one must think it terms of energy, frequency and vibration.”

### Antenna Requirement

The ‘external smart source’ uses Einstein's and Kaluza's 4th dimension to transmit information into our three dimensional world. Also stated, mathematically this dimension is much smaller than anything discovered within quantum mechanics. The size of Planck Length, is 10 times 10⁻³⁶ meters; extremely, extremely small. Quoting today's science:

“Physicists primarily use the Planck length to talk about things that are ridiculously tiny. Specifically; too tiny to matter. By the time you get to (anywhere near) the Planck length it stops making much sense to talk about the difference between two points in any reasonable situation. Think of anything at all: that's way, way, way bigger. A hydrogen atom is about 10 trillion trillion Planck lengths across (which, in the pantheon of worldly facts, ranks among the most useless).”
Ironically, this Planck Length size existed at the beginning of the universe, per the Big Bang scientific theory. This is where the scientist's name Planck is associated, Planck time and Planck length. What could be implied here is that our science today could be ignoring a very important ingredient required in reverse engineering our Universe. Therefore, in order to get an antenna to transmit and receive information within this 4^{th} dimension, we needed to seek information ‘beyond normal’, or as physics would call it, a paranormal means.

### Metaphysical Antenna

Having seventeen years' experience in deep space missions and radar, plus the researching conducted for authoring a book, one could add the Great Pyramid of Giza as being also an antenna to its many list of attributes. Before the granite casing was removed, the structure displayed a very narrow beam of light into the sky, which could be seen from many miles, every equinox and vernal equinox. The pyramid expressing the characteristics of a parabolic dish, a thirteen acre parabolic dish. The pyramid imitates a tetrahedron crystal, which expands its attributes to much more than just being an antenna. Putting two tetrahedron crystals together at their bases creates an octahedron crystal, which appears commonly within many crystal forming structures in our physical world.

Why does the pyramid need to be so huge? The size was required to keep it in resonance. Its natural resonant frequency had to be equal to the earth's resonant frequency, in order to maintain a constant state of resonance. Once a crystal is in resonance it will pass EM waves through it. In the pyramid's application, it will act like a receiving antenna for a very, very, very, weak signal, going into a maser like device for amplification, then into additional resonant chambers to demodulate signals for different application purposes. The invention's antenna is the octahedron crystal, to be used to interact with the ‘external smart source’. The octahedron crystal holds many more important attributes, which one attribute providing an important capability for the technology to teleport using low energy waves.

### Signal and Octahedron Crystal

The ‘external smart source’ signal coming into our three dimensional space through Einstein's and Kaluza's 4^{th} dimension is extremely tiny and thus weak in comparison to our current knowledge and associated equipment. One primary reason why teleportation is being viewed as science fiction and impossible by the scientific community. But, the Chinese, with their TK experiments proved with brain waves the signal can be detected and altered with extremely low energy waves, one cannot get much lower energy. It should be noted here, many other countries also have conducted these same experiments, however, just have not published their results. In addition, hi-energy waves have allegedly interactively affected the signal causing the ‘cut effect’ to have happened in many cases. Tesla's high energy wave experiments most definitely experienced this phenomena, as the alleged military experiments.

Octahedron crystal with its unique properties in conjunction with current technology provides the capability to determine the specific attributes of this incoming signal which creates objects. In research obtained for authoring the book, and expressed in the unified field theories of Einstein and Kaluza, this signal is comprised of extremely tiny electromagnetic waves (possible String Theories?). The object's information being modulated on the magnetic portion of the wave; as being widely used by our communications technology today. With the octahedron crystal being in resonance and coming into contact with the object, it detects the signal and passes only the electrical portion through it—180 degrees out of phase. The next step is to amplify and extract the ingredients needed in creating an opposite, complementary signal to dematerialize or ‘cut’ the object—the first step in creating real teleportation.

One could visualize this signal being similar to the signals coming from deep space, beyond our solar system from NASA's spacecrafts and without any of the background noise. Using a paramp like device and a series of amplifiers, plus other needed ingredients, the carrier wave and phase, can be detected in order to complete the low energy teleportation application. A key point here is the original signal is not needed just it attributes are required for teleportation. By using a harmonic frequency to pump the signal, i.e. a person pumping a swing in the park to enlarge its oscillation, these attributes can be detected.

### Teleporter

The teleporter's function is to perform the object's selection and cut process within our cut/paste analogy. It accomplishes this by dematerializing the object and thus removing it from our three dimensional world. Does this violate the First Law of Thermodynamics? No, for two reasons, the complete object still resides in the ‘external smart source’, which is the governing authority of all natural laws and second, instantly it is recreated at its pasted (new) destination. Keep in mind, time is only a factor within our three dimensions, in all probability it would not be in existence within this 4^{th} dimension and the ‘external smart source’.

The teleporter device, being electronics to produce frequencies to both put the crystal in resonance and to negate the signal going to the object. This dematerialization of the object could be achieved in two entirely different methods. One could be to bombard the object with high energy EM waves, thus saturating all the fields associated with it—possibly fatal to all animate (human) objects. The other method just negates the signal creating the object using low energy EM waves; however, to perform this it is required to know the critical signal attributes. Why would either of these conditions of creating dematerialization convert into a teleportation of an object?

There being a required two-way communication between the object and the ‘external smart force’ for many reasons, i.e. to track its movements. Inhibiting the creation of an object by negating the incoming EM waves would open or break both communication avenues. This would initiate a series of intelligent responsive actions within the ‘external smart source’, a major one would have to be has the First Law of Thermodynamics been violated? We do know from all the teleportation events happening, this ‘external smart source’ does know how to teleport. What we didn't know, how to initiate it and how to control the specific destination.

To understand how this application works one has to understand what is presumably happening within the ‘external smart source’, also keeping in mind, everything is happening instantaneously. The teleporter's negating signal is acting between Einstein's 4^{th} dimension and the object, inhibiting the creation of the object. Thus the object no longer exists in our three dimensions, but still the entire object and ‘all its attributes, if humans’ existing in the ‘external smart source’. This ‘external smart source’, presuming to be computer-like, would first run a series of tests to determine which action to take when not receiving the signal back from the object. One of those tests being; is the object being teleported? If so, it will continue resending the information until the object returns it signal. If the object was moving when the communication was broken, the ‘external smart source’ would keep sending information down that heading. What then would be needed at a desired destination, down that heading to stop the process, or paste it?

### Landing Zone

The landing zone's function then is, the paste process. By removing the teleporter's signal restores the entire object, including all it attributes, at a preselected destination; keeping in mind this is happening instantaneously within our three dimensions. The landing zone must also have, besides the technology to inhibit the teleporter's signal, a designated empty space free of any other objects. Teleportation is capable of embedding matter into other matter, as noted in some tornados and alleged military experiments.

The technology within the landing zone creates a momentarily field that intersects with the incoming beam of information to recreate the object. All the field needs to do is negate the field surrounding the dematerialized object. It should be noted, the beam of information, being extremely, extremely narrow was positioned using the coordinates obtained from the GPS devices (satellites triangulation) being aimed specifically at the landing zone. The beam is traveling at the line of sight, and as illustrated in the TK experiments it is capable to penetrate solid objects. Thus could travel through the interior of the earth, or any other objects; i.e. anything on earth, or in whole universe.

Human teleportation is also a reality, for two major reasons, first the transfer occurs instantaneously, within a blink of an eye; second everything goes across, both all physical and non-physical attributes, the whole enchilada. We know this to be true from all the alleged teleporting events happening today, including UFOs. Human teleporting is much quicker, less expensive, safer and more reliable than any current transportation system existing today. First generation teleportation would concentrate on teleporting inanimate objects versus humans, until both the technology and procedures are tested, refined and proven secure.

Are drones the real answer to package delivery?

1. The invention is apparatuses to dematerialize objects at their initial origin, and rematerializes them at a selected destination instantaneously. The invention, effectively, cuts and pastes any selected object to anywhere in the Universe transferred by the means of the invention's low energy technology for teleportation.
An apparatus containing an octahedron crystal, to be used in conjunction with electronic amplifiers, and transmitters in forming an encased field around an object, which instigates a low energy teleportation process. This apparatus, termed a teleporter in this patent, could be either external or internally located within an object; its objective to ‘cut’ or, dematerialize an object.
An ‘external smart source’, which is naturally creating objects keeps sending its object's information signal on a path to a selected destination. Another apparatus at the destination applies a complementary field to the inbound signal to ‘paste’ or rematerializes the object instantaneously. This apparatus, called a landing zone, capable of rematerializes large inanimate and animate objects—including humans.
